(19) United States
(12) Patent Application Publication
(10) Pub. No.: US 2017/0069038 A1
(43) Pub. Date: Mar. 9, 2017

(54) ELECTRONIC DEVICE AND METHOD FOR SEEKING HELP IN A SOCIAL NETWORK

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HSIU-CHEN LIN, New Taipei (TW); CHIH-YUAN HUANG, New Taipei (TW)

(21) Appl. No.: 14/879,659

(22) Filed: Oct. 9, 2015

(30) Foreign Application Priority Data
Sep. 7, 2015 (TW) 104129535

(51) Int. Cl. G06Q 50/00; G06Q 30/00

(52) U.S. Cl. CPC G06Q 50/01; G06Q 30/016

(57) ABSTRACT

In a method for seeking help in the social network executed in a server, a plurality of electronic devices is connected with the server. When a user of an electronic device registers the server, a social network account is input to the server. The social network account is used to obtain information of friend accounts, so that the server can select one or more friends corresponding to the friend accounts to help the user based on the obtained information and one or more conditions input by the user of the electronic device, when the user of the social network account gets into trouble or encounters a problem.

### CROSS-REFERENCE TO RELATED APPLICATIONS

This application claims priority to Taiwanese Patent Application No. 104129535 filed on Sep. 07, 2015, the contents of which are incorporated by reference herein.

### FIELD

The subject matter herein generally relates to a social network, and particularly to an electronic device and a method for seeking help in the social network.

### BACKGROUND

Social networks attract more and more people. People can make hundreds of friends in a social network, and they can seek help from their online friends via the social network when they get into trouble or encounter a problem.

### BRIEF DESCRIPTION OF THE DRAWINGS

Implementations of the present technology will now be described, by way of example only, with reference to the attached figures.

FIG. 1 is a block diagram of one example embodiment of a server connecting with electronic devices.

FIG. 2A-2B is a block diagram of one example embodiment of a hardware environment for executing a help system.

FIG. 3 is a block diagram of one example embodiment of modules of the help system in FIG. 1.

FIG. 4 is a diagram of one example embodiment of a data table of information of friend accounts.

FIG. 5 is a flowchart of one example embodiment of a help method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

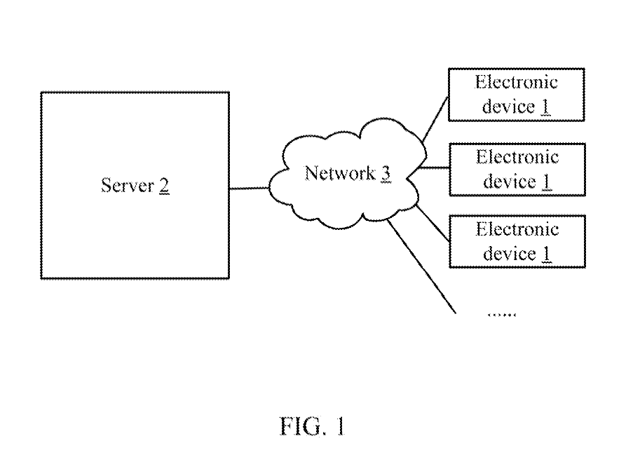

FIG. 1 is a block diagram of one example embodiment of a server 2 connecting with electronic devices 1. In at least one embodiment, a plurality of electronic devices 1 are connected to the server 2 via a network 3, so that each of the electronic devices 1 can communicate with the server 2 through the network 3. The electronic device 1 can be a portable device which has a communication function, such as a smart phone, a personal digital assistant, or the like. The server 2 can be a computing device which has a communication function, such as a computer, or the like. The network 3 can be enterprise Intranet, Internet, Global System of Mobile communication (GSM), Wideband Code Division Multiple Access (WCDMA), or the like.

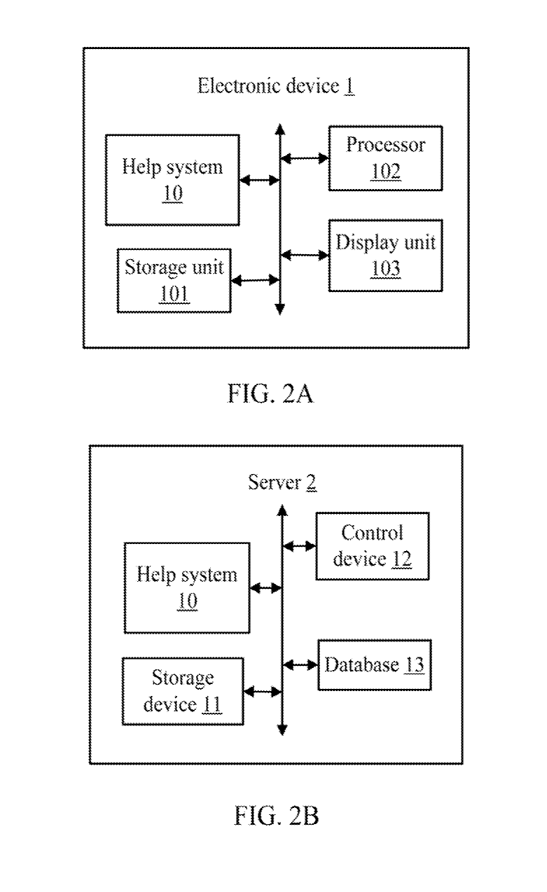

FIGS. 2A-2B is a block diagram of one example embodiment of a hardware environment for executing a help system 10. In at least one embodiment, the help system 10 is installed in and run by the electronic device 1 and the server 2. The server 2 can include, but is not limited to, a storage device 11, at least one control device 12, and a database 13. The electronic device 1 can include, but is not limited to, a storage unit 101, at least one processor 102, and a display unit 103.

The storage device 11 and the storage unit 101 can include various types of non-transitory computer-readable storage media. For example, the storage device 11 and the storage unit 101 can be an internal storage system, such as a flash memory, a random access memory (RAM) for temporary storage of information, and/or a read-only memory (ROM) for permanent storage of information. The storage device 11 and the storage unit 201 can also be an external storage system, such as a hard disk, a storage card, or a data storage medium. The storage device 11 and the storage unit 101 can store the computerized codes of function modules of the help system 10. The at least one control device 12 and the at least one processor 102 can be a central processing unit (CPU), a digital signal processor, a single chip, an application-specific integrated circuit (ASIC), or a field programmable gate array (FPGA), for example. The at least one control device 12 and the at least one processor 102 can execute computerized codes of the function modules of the help system 10 to realize functions of the server 2 and the electronic device 1. The database 13 can be a hierarchical database, a network database, a relation database, or the like. The database 13 can store information of online friends of a user. The display unit 103 can be a liquid crystal display (LCD), an organic light-emitting diode (OLED) display, or the like. The display unit 103 can display the information of online friends of the user. FIG. 2A-2B illustrates only one example of the hardware environment that can include more or fewer components than illustrated, or have a different configuration of the various components in other embodiments.

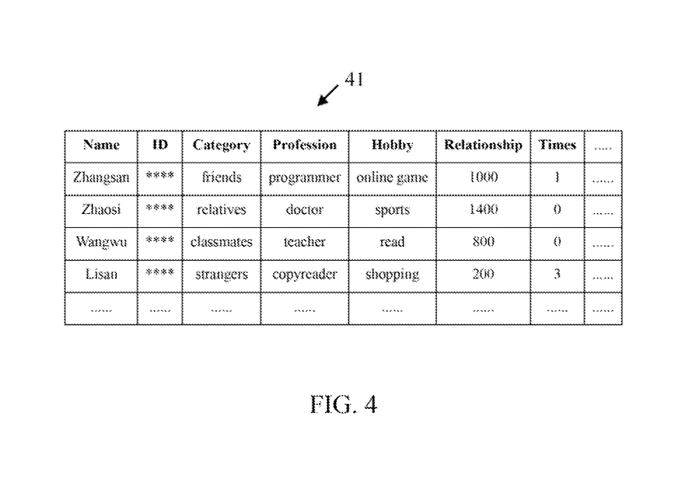

In at least one embodiment, when the electronic device 1 runs the help system 10 for the first time, the help system 10 prompts a user of the electronic device 1 to input a frequently-used social network account (hereinafter, the frequently-used account). According to the frequently-used account input by the user, the server 2 can obtain information of accounts of friends of the frequently-used account (hereinafter, the friend accounts) regularly from the social network when the help system 10 is run by the server 2. The obtained information can be stored in a data table of the database 13. When the user gets into trouble or encounters a problem, the server 2 can select one or more of the friend accounts who may have the ability to help the user based on the stored information. For example, as shown in FIG. 4, the information of the friend accounts is stored in the data table 41. The data table 41 shows that “Zhangsan” is a friend of the frequently-used account, the user the “Zhangsan” is a programmer, and is interested in online games. Thus, if the user of the electronic device 2 encounters a programming or online game problem, “Zhangsan” can be selected from the friend accounts the to help the user, based on the information stored in the data table 41.

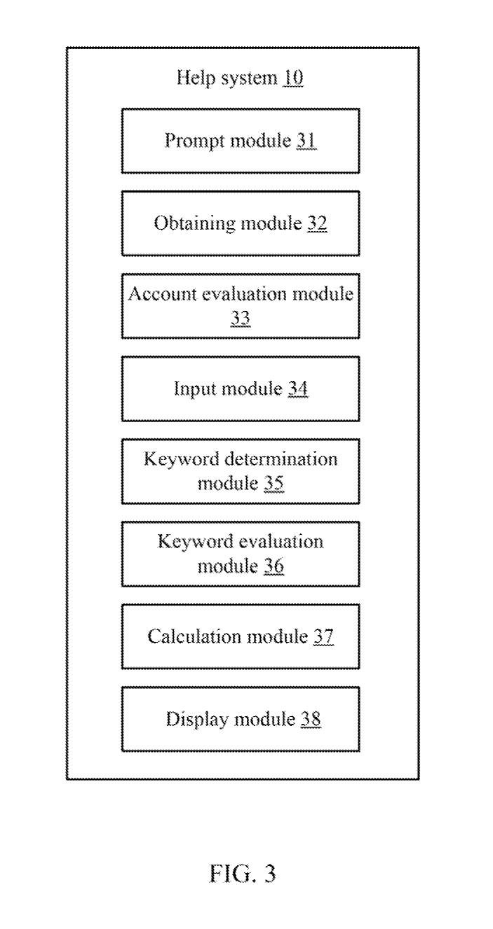

FIG. 3 is a block diagram of one embodiment of modules of the help system 10. In at least one embodiment, the modules of the help system 10 can include, but are not limited to, a prompt module 31, an obtaining module 32, an account evaluation module 33, an input module 34, a keyword determination module 35, a keyword evaluation module 36, a calculation module 37, and a display module 38. In the embodiment, the modules 31-33 and 35-37 are executed in the server 2, the modules 24 and 28 are executed in the electronic device 1. The modules 31-38 can include computerized codes in the form of one or more programs, which are stored in the storage device 11 and the storage unit 101.

When a user of the electronic device 1 registers on the server 2, the prompt module 31 of the server 2 prompts the user to input a frequently-used social network account. The frequently-used account can be an account of QQ application, an account of WetChat application, or the like.

When the user logins into the server 2, the obtaining module 32 of the server 2 obtains the information of the friend accounts regularly from the social network, and stores the obtained information in the database 13.

In at least one embodiment, according to the frequently-used account input by the user, the obtaining module 32 can obtain the information of the friend accounts via one or more application program interfaces (APIs) provided by the social network. The information of the friend accounts can include, but is not limited to, an ID of each of the friend accounts (e.g., 12345@qq.com), a category of each of the friend accounts (e.g., classmates, friends, relatives, or strangers), basic information of each of the friend accounts (e.g., age and hobby), a relationship value between each of the friend accounts and the frequently-used account (e.g., a kindness value provided by the social network), and the like. When the information is obtained, the obtaining module 32 stores the obtained information in a data table of the database 13 such as the data table 41 shown in FIG. 4. It is important to note that the data table is not only used to store the obtained information, but also used to record times that each of the friend accounts has been selected to help the user of the frequently-used account (hereinafter, the selected times).

The account evaluation module 33 of the server 2 evaluates each of the friend accounts based on the information of the friend accounts stored in the database, and sets a first evaluation value for each of the friend accounts.

In at least one embodiment, the user of the frequently-used account can make hundreds of friends via the social network, and the user has a different relationship with each friend. For example, if a friend has one or more common hobbies with the user, they may have more common communication topics than others, and more interactions may appear between an account of the friend and the frequently-used account by the social network. Thus, a closer relationship may be generated between the two accounts. The social network generally provides a relationship value such as the kindness value to describe this relationship between each of the friend accounts and the frequently-used account. The greater the relationship value is, the closer the relationship is. Thus, the account evaluation module 33 can set the first evaluation value for each of the friend accounts according to the relationship value between each of the friend accounts and the frequently-used account, which has been obtained by the obtaining module 32. For example, the account evaluation module 33 can set an first evaluation value for a friend account as 5 when the relationship value between the friend account and the frequently-used account is 1000, set a 25 percent increase of the first evaluation value for every 200 relationship value increase, and set a 25 percent reduction of the first evaluation value for every 200 relationship value reduced.

In addition, in at least one embodiment, when the user uses the social network, the user may set the friend accounts as different categories, for example, classmates, friends, relatives, strangers, and the like. The categories set by the user may represent different relationships between the friend accounts and the frequently-used account. For example, obviously, friend accounts in the relative category must be closer with the frequently-used account than friend accounts in the classmate category, the friend accounts in the classmate category must be closer than friend accounts in the stranger category, and so on. Thus, the account evaluation module 33 also can set the first evaluation value for each of the friend accounts according to the category of each of the friend accounts set by the user of the frequently-used account. For example, the account evaluation module 33 can set a first evaluation value of a friend account as 10 when the friend account is set as the relative category by the user of the frequently-used account, set the first evaluation value of the friend account as 5 when the friend account is set as the classmate category, set the first evaluation value of the friend account as 0 when the friend account is set as the stranger category, and the like.

The account evaluation module 33 of the server 2 evaluates each of the friend accounts based on the times that each of the friend accounts is selected, and sets a second evaluation value for each of the friend accounts.

In at least one embodiment, if a friend has helped the user of the frequently-used account one or more times (e.g., the selected times of an account of the friend is not 0), the friend may have a greater chance to be willing to help the user once more than a friend that never helps the user. Thus, it is necessary to set the second evaluation value for friend accounts which have helped the user, so that friends corresponding to those friend accounts may have a greater chance to be selected to help the user under the same constraints. In detail, the account evaluation module 33 can set an second evaluation value of a friend account which never helps the user of the frequently-used account as 0, set an second evaluation value of a friend account which has helped the user once as 5, and set a 25 percent increase of the second evaluation value for every one time increase.

When the user gets into trouble or encounters a problem, the input module 34 of the electronic device 1 receives one or more conditions input by the user for selecting one or more friends to seek help, and transmits the conditions to the server 2. In at least one embodiment, an input interface can be provided by the input module 34 for the user to input the conditions. The conditions can be one or more words, one or more sentences, or the like.

The keyword determination module 35 of the server 2 determines one or more keywords of the conditions when receiving the conditions transmitted by the electronic device 1.

In at least one embodiment, a frequently-used vocabulary list is prestored in the storage device 11 of the server 2 which includes a plurality of frequently-used words such as “game”, “movie”, “social network”, “program”, and the like. When receiving the conditions transmitted by the electronic device 1, the keyword determination module 35 compares each word of the conditions with the frequently-used vocabulary list. If a word of the conditions matches the frequently-used vocabulary, the keyword determination module 35 determines that the word is a keyword of the conditions. For example, if the conditions input by the user is “a man who can write programs”, the keyword determination module 35 compares the “man” and the “program” with the frequently-used vocabulary list successively, if the “program” is a frequently-used vocabulary of the frequently-used vocabulary list, the “program” can be determined as a keyword of the “a man who can write programs”.

When the keywords of the conditions are determined, the keyword evaluation module 36 of the server 2 determines whether the information of the friend accounts includes the keywords. If one or more keywords are included in information of a friend account, the keyword evaluation module 36 sets a keyword evaluation value for the friend account according to the number of the keywords included in the information of the friend account. For example, if the information of the friend account does not include any keywords of the conditions, the keyword evaluation module 36 can set the keyword evaluation value of the friend account as 0. If the information of the friend account includes a keyword of the conditions, the keyword evaluation module 36 can set the keyword evaluation value of the friend account as 1, and a 100 percent increase of the keyword evaluation value for every one keyword increase.

The calculation module 37 of the server 2 calculates a total evaluation value of each of the friend accounts by additive, generates a friend accounts list which includes one or more friend accounts according to the total evaluation value of each of the friend accounts, and sends the generated friend accounts list to the electronic device 1. In at least one embodiment, the calculation module 37 selects one or more friend accounts which have the greater total evaluation value than other friend accounts to generate the friend accounts list.

The display device 28 of the electronic device 1 displays the friend accounts list sent by the server 2 on the display unit 103, so that the user can select one or more friends corresponding to the displayed friend accounts to seek help. In at least one embodiment, when a friend is selected by the user, the server 2 can record that the selected times of an account of the friend increases one.

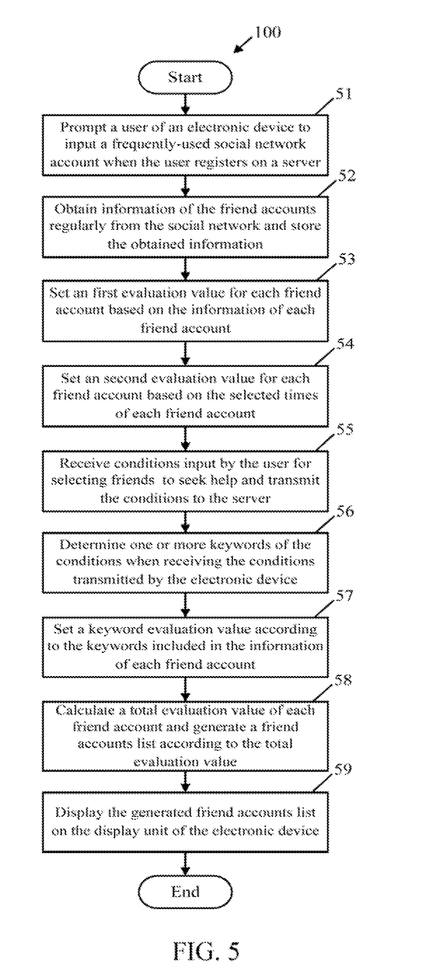

FIG. 5 illustrates an embodiment of a method 100 for seeking help. In at least one embodiment, the method 100 is provided by way of example, as there are a variety of ways to carry out the method 100. The method 100 described below can be carried out using the configurations illustrated in FIGS. 1 and 4, for example, and various elements of these figures are referenced in the explanation of the method 100. Each block shown in FIGS. 1 and 43 represents one or more processes, methods, or subroutines carried out in the method 100. Additionally, the illustrated order of blocks is by example only and the order of the blocks can change. The method 100 can begin at block 31.

At block 51, when a user of an electronic device registers on a server, a prompt module of the server prompts the user to sign into a frequently-used social network account (hereinafter, the frequently-used account). The frequently-used account can be an account of QQ application, an account of WetChat application, or the like.

At block 52, when the user logins into the server, an obtaining module of the server obtains information of accounts of friends of the frequently-used account (hereinafter, the friend accounts) regularly from the social network, and stores the obtained information in a database.

In at least one embodiment, according to the frequently-used account input by the user, the obtaining module can obtain the information of the friend accounts via one or more application program interfaces (APIs) provided by the social network. The information of the friend accounts can include, but is not limited to, an ID of each of the friend accounts, a category of each of the friend accounts, basic information of each of the friend accounts, a relationship value between each of the friend accounts and the frequently-used account, and the like. When the information is obtained, the obtaining module stores the obtained information in a data table of the database. It's important to note that the data table is not only used to store the obtained information, but also used to record times that each of the friend accounts has been selected to help the user of the frequently-used account (hereinafter, the selected times).

At block 53, an account evaluation module of the server evaluates each of the friend accounts based on the information of the friend accounts stored in the database, and sets a first evaluation value for each of the friend accounts.

In at least one embodiment, the user of the frequently-used account can make hundreds of friends via the social network, and the user has a different relationship with each friend from others. The social network generally provides a relationship value such as the kindness value to describe this relationship between each of the friend accounts and the frequently-used account. The greater the relationship value is, the closer the relationship is. Thus, the account evaluation module can set the first evaluation value for each of the friend accounts according to the relationship value between each of the friend accounts and the frequently-used account, which has been obtained by the obtaining module.

In addition, in at least one embodiment, when the user uses the social network, the user may set the friend accounts as different categories, for example, classmates, friends, relatives, strangers, and the like. The categories set by the user may represent different relationships between the friend accounts and the frequently-used account. Thus, the account evaluation module also can set the first evaluation value for each of the friend accounts according to the category of each of the friend accounts set by the user of the frequently-used account.

At block 54, the account evaluation module of the server evaluates each of the friend accounts based on the times that each of the friend accounts is selected, and sets a second evaluation value for each of the friend accounts.

In at least one embodiment, if a friend has helped the user of the frequently-used account one or more times, the friend may have a greater chance to be willing to help the user once more than a friend that never helps the user. Thus, it is necessary to set the second evaluation value for friend accounts which have helped the user, so that friends corresponding to those friend accounts may have a greater chance to be selected to help the user under the same constraints. In detail, the account evaluation module can set a second evaluation value of a friend account which never helps the user of the frequently-used account as 0, set an second evaluation value of a friend account which has helped the user once as 5, and set a 25 percent increase of the second evaluation value for every one time increase.

At block 55, when the user gets into trouble or encounters a problem, an input module of the electronic device receives one or more conditions input by the user for selecting one or more friends to seek help, and transmits the conditions to the server. In at least one embodiment, an input interface can be provided by the input module for the user to input the conditions. The conditions can be one or more words, one or more sentences, or the like.

At block 56, a keyword determination module of the server determines one or more keywords of the conditions when receiving the conditions transmitted by the electronic device.

In at least one embodiment, a frequently-used vocabulary list is prestored in the storage device of the server which includes a plurality of frequently-used words such as “game”, “movie”, “social network”, “program”, and the like. When receiving the conditions transmitted by the electronic device, the keyword determination module compares each word of the conditions with the frequently-used vocabulary list. If a word of the conditions matches the frequently-used vocabulary, the keyword determination module determines that the word is a keyword of the conditions.

At block 57, when the keywords of the conditions are determined, the keyword evaluation module of the server determines whether the information of the friend accounts includes the keywords. If one or more keywords are included in information of a friend account, the keyword evaluation module sets a keyword evaluation value for the friend account according to the number of the keywords included in the information of the friend account.

At block 58, a calculation module of the server calculates a total evaluation value of each of the friend accounts by addition, generates a friend accounts list which includes one or more friend accounts according to the total evaluation value of each of the friend accounts, and sends the generated friend accounts list to the electronic device. In at least one embodiment, the calculation module selects one or more friend accounts which have the greater total evaluation value than other friend accounts to generate the friend accounts list.

At block 59, a display device of the electronic device displays the friend accounts list sent by the server on the display unit, so that the user can select one or more friends corresponding to the displayed friend accounts to seek help. In at least one embodiment, when a friend is selected by the user, the server can record that the selected times of an account of the friend increases one.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A method for seeking help in the social network being executed by at least one control device of a server, the method comprising:
obtaining information of a plurality of friend accounts of a frequently-used social network account from the social network according to the frequently-used account input by a user of an electronic device connecting with the server;
setting a first evaluation value and for each of the friend accounts based on the information of the friend accounts;
setting a second evaluation value for each of the friend accounts based on the information;
receiving conditions from the electronic device;
determining one or more keywords of the received conditions;
setting a keyword evaluation value for each of the friend accounts according to the number of the keywords comprised in information of each of the friend accounts;
calculating a total evaluation value of each of the friend accounts by addition, and generating a friend accounts list according to the total evaluation value; and
sending the generated friend accounts list to the electronic device so that the user of the electronic device can select one or more friends corresponding to the friend accounts list to ask for help.

2. The method according to claim 1, further comprising:
increasing times that a friend account has been selected by one when the user of the electronic device selects the friend account.

3. The method according to claim 1, wherein the information of each of the friend accounts comprises a category of each of the friend accounts, a relationship value between each of the friend accounts and the frequently-used account, and times that each of the friend accounts has been selected.

4. The method according to claim 3, further comprising:
setting the first evaluation value for each of the friend accounts based on the relationship value between each of the friend accounts and the frequently-used account, or the category of each of the friend accounts.

5. The method according to claim 3, further comprising:
setting the second evaluation value for each of the friend accounts based on the times that each of the friend accounts has been selected.

6. The method according to claim 1, wherein the conditions input by the user of the electronic device include one or more words, or one or more sentences.

7. A server comprising:
at least one control device; and
a storage device storing one or more programs which when executed by the at least one control device, causes the at least one control device to perform operations comprising:
obtaining information of a plurality of friend accounts of a frequently-used social network account from the social network according to the frequently-used account input by a user of an electronic device connecting with the server;
setting a first evaluation value and for each of the friend accounts based on the information of the friend accounts;
setting a second evaluation value for each of the friend accounts based on the information;
receiving conditions from the electronic device;
determining one or more keywords of the received conditions;
setting a keyword evaluation value for each of the friend accounts according to the number of the keywords comprised in information of each of the friend accounts;
calculating a total evaluation value of each of the friend accounts by addition, and generating a friend accounts list according to the total evaluation value; and
sending the generated friend accounts list to the electronic device so that the user of the electronic device can select one or more friends corresponding to the friend accounts list to ask for help.

8. The server according to claim 7, wherein the operations further comprise:
increasing selected times of a friend account by one when the user of the electronic device selects the friend account.

9. The server according to claim 7, wherein the information of each of the friend accounts comprises a category of each of the friend accounts, a relationship value between each of the friend accounts and the frequently-used account, and times that each of the friend accounts has been selected.

10. The server according to claim 9, wherein the operations further comprise:
setting the first evaluation value for each of the friend accounts based on the relationship value between each of the friend accounts and the frequently-used account, or the category of each of the friend accounts.

11. The server according to claim 9, wherein the operations further comprise:
setting the second evaluation value for each of the friend accounts based on the times that each of the friend accounts has been selected.

12. The server according to claim 7, wherein the conditions input by the user of the electronic device include one or more words, or one or more sentences.

13. A non-transitory computer-readable storage medium having stored thereon instructions that, when executed by at least one control device of a server, causes the at least one control device to perform a method for seeking help in the social network, the method comprising:
obtaining information of a plurality of friend accounts of a frequently-used social network account from the social network according to the frequently-used account input by a user of an electronic device connecting with the server;
setting a first evaluation value and for each of the friend accounts based on the information of the friend accounts;
setting a second evaluation value for each of the friend accounts based on the information;
receiving conditions from the electronic device;
determining one or more keywords of the received conditions;
setting a keyword evaluation value for each of the friend accounts according to the number of the keywords comprised in information of each of the friend accounts;
calculating a total evaluation value of each of the friend accounts by addition, and generating a friend accounts list according to the total evaluation value; and
sending the generated friend accounts list to the electronic device so that the user of the electronic device can select one or more friends corresponding to the friend accounts list to ask for help.

14. The non-transitory computer-readable storage medium according to claim 13, wherein the method further comprises:
increasing times that a friend account has been selected by one when the user of the electronic device selects the friend account.

15. The non-transitory computer-readable storage medium according to claim 13, wherein the information of each of the friend accounts comprises a category of each of the friend accounts, a relationship value between each of the friend accounts and the frequently-used account, and times that each of the friend accounts has been selected.

16. The non-transitory storage medium according to claim 15, wherein the method further comprises:
setting the first evaluation value for each of the friend accounts based on the relationship value between each of the friend accounts and the frequently-used account, or the category of each of the friend accounts.

17. The non-transitory storage medium according to claim 15, wherein the method further comprises:
setting the second evaluation value for each of the friend accounts based on the times that each of the friend accounts has been selected.

18. The non-transitory storage medium according to claim 13, wherein the conditions input by the user of the electronic device include one or more words, or one or more sentences.
